(19) United States
(12) Patent Application Publication
(10) Pub. No.: US 2007/0189112 A1
(43) Pub. Date: Aug. 16, 2007

(54) Procedure and device for homogenizing

(76) Inventor: Sandra Knape, Berlin (DE)

Correspondence Address: FULBRIGHT & JAWORSKI, LLP, 1301 MCKINNEY, SUITE 5100, HOUSTON, TX, 77010-3095, US

(21) Appl. No.: 11/433,490

(22) Filed: May 12, 2006

(30) Foreign Application Priority Data
Feb. 16, 2006 (EP) EP 06003157.2

(51) Int. Cl. B01F 13/02

(52) U.S. Cl. 366/104

(57) ABSTRACT

A process for homogenizing a pumpable product, in which the product is pressurized and homogenized in an homogenization means equipped with a drive which has a drivable rotor rotatably mounted in a housing, and a stator that is stationary or drivable at an adjustable relative speed relative to the rotor, characterised in that a pressure which can be set independently of the drive of the homogenization means is applied to the product upstream of the homogenization means by means of a pump means equipped with a separate drive, the pressure being controlled such that no cavitation occurs in the homogenization means, and a device for carrying out the process.

### CROSS-REFERENCE TO RELATED APPLICATIONS

This application claims priority to EP 06003157.2 filed Feb. 16, 2006.

### Technical Field

The invention relates to a process for homogenizing a pumpable product, in which the product is pressurized and homogenized in an homogenization means equipped with a drive which has a drivable rotor rotatably mounted in a housing, and a stator that is stationary or drivable at an adjustable relative speed relative to the rotor, and to a device for homogenizing a pumpable product, with an homogenization means which has a drivable rotor rotatably mounted in a housing, and a stator that is stationary or drivable at an adjustable relative speed relative to the rotor, and with a pump means upstream of the homogenization means, of the kind known from EP 1 475 143 A1.

### BACKGROUND OF THE INVENTION

In the context of the present invention, the term “homogenization” any way of increasing the interface between at least two phases of a pumpable medium or product, i.e. in particular also dispersing or emulsifying.

The homogenization means used in the context of the invention is of the rotor-stator type and consists of a stationary member, the stator, and a member that moves at a predetermined speed, usually with a high number of revolutions, the rotor. Although a stator is a term generally used to refer to a stationary member, the invention also encompasses those types in which the stator is likewise driven in order to achieve a certain relative speed, for example in order to achieve a desired ratio of pumping and shear energy input.

In the known device mentioned at the beginning, the product is subjected, in a space between the rotor and the stator, to very powerful shearing action, which is proportional to the (relative) speed of rotation (10 to 30 m/s are customary) and to the width of the gap (0.1 to a few millimetres are customary). The shearing action causes droplets to break down. An emulsion obtained in this way can be stabilized by emulsifying agents.

In principle, it is the case that, as the speed increases, the energy input per volume passed through rises. In rotor-stator systems, the energy used to enlarge the interphase is relatively small compared to the total amount of energy input, i.e. the efficiency is generally low and the greater part of the energy is converted into frictional heat.

From the point of view of the principle involved, rotor-stator homogenizers are also radial pumps and are suitable for generating a slight partial vacuum on the intake side and a slight overpressure on the outlet side. To support the pumping effect, additional pump impellers can be attached on the suction side (EP 0 896 833) or on the delivery side (DE 296 06 962). What all these known systems have in common is the fact that the pump impellers are joined to the rotor of the homogenizer such that they cannot rotate independently. The consequence of this is that the relationship between the shear energy and volume flow is a parameter that is dependent on the rotor-stator geometry and the product, and which cannot be influenced by the operator.

Modern process lines often operate under a vacuum, i.e. at less than 300 mbar, for example. The homogenization process takes place at elevated temperatures as a rule. This means that the working pressure can be close to the vapour pressure of the liquids to be homogenized. In this situation, because of local speed peaks, usually in backflow zones of the rotor blade, there may be a local drop in the static pressure to below the vapour pressure, so that small vapour bubbles form, which may collapse again after a very short time and damage the pump impeller (cavitation).

With the aim of reducing the tendency to cavitation, various methods have been adopted. More with the objective of increasing the throughput than of raising the static pressure before the homogenizer, EP 1 475 143 A1 proposed a pump means coupled to the rotor. This kind of measure has proved useful in principle, but it is nevertheless disadvantageous if a product is to be conveyed or delivered without any input of shear energy, if possible, because the input of shear and pumping energy are always coupled in such a design, of course.

The problem of the invention consists in improving the known process and the known device for homogenizing a pumpable product in such a way that, on the one hand, when the working pressures are close to the vapour pressure, the maximum inputs of shear energy are possible while the tendency to cavitation remains low, and that, on the other hand, the product can be removed gently as required, without introducing high levels of shear energy.

### BRIEF SUMMARY OF THE INVENTION

This problem is solved in the process in accordance with the invention in that a pressure which can be set independently of the drive of the homogenization means is applied to the product upstream of the homogenization means and independently of its drive by means of a pump means equipped with a separate drive, the pressure being controlled such that no cavitation occurs in the homogenization means.

Although in principle, various sensors could be used as control means to avoid cavitation, such as acoustic sensors, which detect the occurrence of cavitation at an early stage, it has proven particularly advantageous to use map-controlled closed-loop control, in which the most important operating parameters, in particular the speed of the homogenization means and the nature of the product being processed in each case, are stored in a control unit and, depending on that, the necessary pressure upstream of the homogenization means is stored and/or the required speed of the pump means which guarantees that pressure, so that ultimately no cavitation occurs. The characteristic map can either be determined in advance by means of measurements, or it can be based on data which have been calculated with the aid of theoretical physical correlations. The properties of the product concerned can be taken into account either in that different types of product are stored in the characteristic map, which have to be selected as such in operation, such as “product 1”, “product 2” etc., or in that one or more key product characteristics, such as the viscosity, are supplied to the control unit or are determined by conducting measurements during the on-going operation, so that the control unit “knows” which or what kind of product is being processed and can select the corresponding characteristic map, or the appropriate region of the characteristic map.

It is therefore conveniently provided that the pressure is controlled by a map-controlled control unit, a characteristic map containing at least the speed of the homogenization means and the nature of the product as input parameters and based on data either measured in advance or calculated. Variables as input information for the control unit are at least the pressure upstream of the homogenization means and possibly measured product characteristics, such as viscosity, temperature, particle size etc.

A further preferred embodiment consists in having the pressure controlled by a control system with a computing unit, wherein the computing unit uses empirically or theoretically determined correlations between at least the speed of the homogenization means and at least one characteristic property of the product, on the one hand, and the pressure required in order to avoid cavitation, on the other hand, in order to calculate the pressure on that basis. With this kind of embodiment, no predetermined characteristic map is required, though this presupposes that the basic correlations in the form of calculation formulae for the pressure are sufficiently accurate, so that in practical operation, on the one hand, no cavitation occurs and, on the other hand, the pressure is not set unnecessarily high.

The problem is solved in the device in accordance with the invention by the measure that the pump means can be driven independently of the homogenization means, there being associated with the pump means a control unit connected to a pressure sensor disposed upstream of the homogenization means in order to detect a pressure, the control unit being adapted to adjust the pressure in such a way that no cavitation occurs in the homogenization means.

It is appropriately provided here that the control unit is map-controlled, with a characteristic map containing at least the speed of the homogenization means and the nature of the product as input parameters and based on data either measured in advance or calculated.

One preferred variant consists in the control unit having a computing unit which is arranged in such a way that it uses empirically or theoretically determined correlations between at least the speed of the homogenization means and at least one characteristic property of the product, on the one hand, and the pressure required in order to avoid cavitation, on the other hand, in order to calculate the pressure on that basis.

The computing unit preferably consists of a microcomputer with a central processing unit and a memory in which the required system parameters (technical properties of the pump means and homogenization means) and the product characteristics needed in order to calculate the required pressure and calculation equations are stored.

The control unit can be designed jointly for the pump means and the homogenization means.

This creates the possibility of achieving, independently of one another, the maximum inputs of shear energy and/or high pumping energy inputs and thus great process variability. With an independently drivable pump means upstream of the homogenization means, the pressure present at the homogenizer can be increased significantly if the need arises, so that the difference between it and the vapour pressure can be increased and the cavitation tendency reduced. Conversely, when the homogenization means is idle or operating slowly (low shear), a product stream can be obtained by driving the pump means gently, whether this is done for the purposes of withdrawal, input, heat exchange, cleaning etc. . . .

In addition, the possibility exists, because of the structural separation of the homogenization and pump means, of achieving a delivery of solids and/or liquids in a simple manner immediately upstream of the rotor-stator system, it being possible to use one and the same nozzle for input and optionally for withdrawal.

The invention makes it possible to have a modular structure and also to integrate it into existing production lines.

It can be provided that the pump means and the homogenization means are disposed in a common housing. Alternatively, it can be provided that the pump means has a separate pump housing. In this case, it could be provided that the housing of the homogenization means is connected to the pump housing.

The homogenization means and the pump means may be disposed spatially apart from one another and connected by a conduit.

It is conveniently provided that the pump means is disposed vertically beneath a product boiler.

The pump means can be designed as a single or multi-stage radial or axial pump.

For special applications, it can be provided that the pump means and/or the homogenization means include(s) sterilisable mechanical axial face seals.

It is preferably provided that at least one fitting, in particular a valve, is disposed between the pump means and the homogenization means. The at least one fitting can be designed to take in additives by suction.

In addition, it can be provided that the at least one fitting is designed as a product outlet.

A pressure measuring means and/or a particle size sensor and/or a flow meter can be disposed between the pump means and the homogenization means.

In addition, it can be provided that a pressure measuring means and/or a particle size sensor and/or a flow meter is/are disposed downstream of the homogenization means.

A common open or closed-loop control can be provided for the homogenization means and the pump means, wherein data from the above-mentioned pressure, particle size and flow sensors can be used as input parameters for the closed-loop control, in addition to certain process settings.

In certain practical uses, it can be appropriate that the homogenization means includes a pumping stage, in particular a pump impeller, which is joined to the rotor in a manner known per se, such that it cannot rotate independently.

The invention further provides that, between the rotor and the stator, there is a free cross-section, which decreases in the direction of flow.

As a further development of the invention, it can be provided that a by-pass branch containing a heat exchanger is disposed in a parallel circuit to the homogenization means and surrounding the latter, through which the product can be conducted if necessary, instead of through the homogenization means.

The invention preferably provides that the pump means is designed for low-shear transport.

In particular, it can be provided that the pump means makes it possible to have a delivery pressure of up to 5 bar.

One major aspect of the invention is the combination of the pump and the homogenization means, wherein the speed of the pump is always controlled and the speed of the homogenization means is optionally also controlled. The speed control is orientated towards settings and the measured value between the pump and the homogenizer.

The measured value may consist generally of a quantitative measurement, in which case pressure is the only meaningful measured value for the essential purpose of avoiding cavitation. As a protective measured value, it would be conceivable to refer to the acoustic intensity (not good for closed-loop control). Further measured values for assessing quality (e.g. particle measurement or temperature increase) would at most make sense after passing through the homogenizer.

A parameter for closed-loop control is a particular minimum pressure, which should always be exceeded, as the admission pressure upstream of the homogenizer, that pressure still being a function of the homogenizer speed and possibly of other influencing variables.

According to Bernoulli (friction-free) the entire available energy can be regarded either as static or as dynamic pressure. In order to avoid cavitation, the static pressure must not be less than the vapour pressure of the mixture (in the case of multi-phase emulsions, also occasionally the vapour pressure of the more volatile component). The portion of the dynamic pressure is proportional to the square of the peripheral speed of the rotor in the homogenizer. The faster the rotor turns therefore, the more the available static pressure drops.

In order not to fall below the critical static pressure, and yet to be able to apply very high dynamic pressures all the same, the remaining possibility is to increase the available overall pressure.

In order avoid cavitation therefore, the admission pressure has to be all the higher, the greater the homogenizer speed is. In this connection, there is a dependence between the homogenizer geometry (general cavitation tendency) and the physical characteristics (boiling point and flow properties) of the products. The function can be available as an empirical value (characteristic curve(s), characteristic map) and is recorded from one or more corresponding measured curves, where, depending on the admission pressure, it is possible to determine the critical speed as of which cavitation occurs.

The input parameter for the controller is thus a target pressure curve obtained by measurement or calibration, as a function of the homogenizer speed and the product concerned.

A further input parameter for the controller can be the characteristics of the pumping stage. This depends on the geometry and size of the pump, and above all on the product characteristics. The control parameters to be set also depend on the operating mode (see the table provided further down).

### BRIEF DESCRIPTION OF THE DRAWINGS

Further benefits and features of the invention will become apparent from the following description of a preferred working embodiment, reference being made to a drawing, in which the (single)

FIG. 1 shows a schematic representation of a device in accordance with the invention for homogenizing a pumpable product.

### DETAILED DESCRIPTION OF THE INVENTION

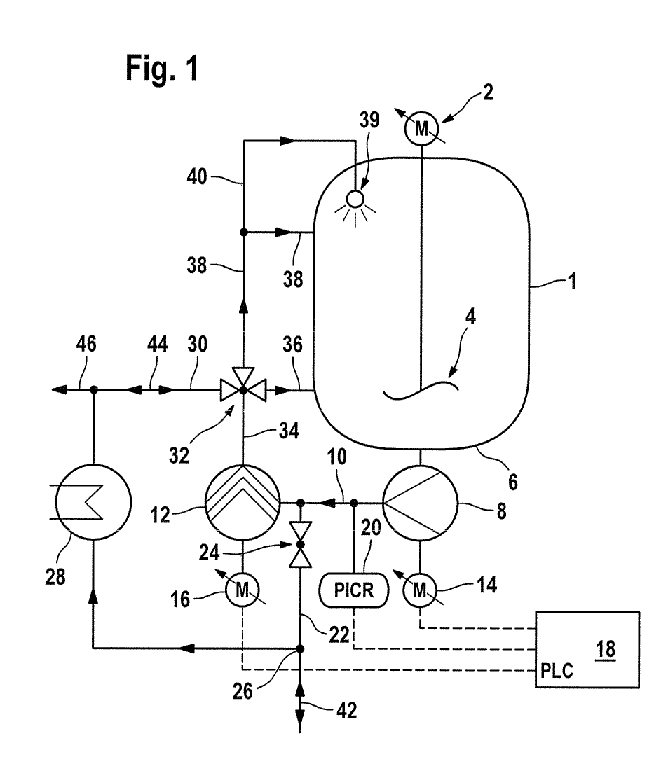

The system, which is merely shown in a schematic and simplified form in FIG. 1, for homogenizing or emulsifying a product first of all includes a boiler 1 in a vertical orientation, which is provided with a stirrer 4 driven by a stirrer motor 2, the rotational axis of the stirrer being the same as the vertical longitudinal axis of the boiler in this example.

A pump 8 as the pump means in accordance with the invention is disposed beneath a boiler floor 6, communicating via a conduit 10 with an homogenizer 12, which forms the homogenization means of the invention.

The pump 8 and the homogenizer 12 are in each case driven by drive motors 14, 16, which can be controlled (open or closed loop) independently of one another, the open or closed loop control being effected by a control unit 18.

On the input side, the control unit 18 is connected to measuring sensors, which are indicated by 20 and which may be pressure, temperature, particle size and/or flow quantity sensors; these sensors may be disposed, as shown, between the pump 8 and the homogenizer 12 and additionally, where appropriate, in other locations in the system, such as downstream of the homogenizer and in the boiler. In addition, the control unit 18 receives input signals in the form of constant process settings and, where applicable, current user interventions in a manner known per se. The signal lines are indicated by dashed lines in FIG. 1.

Between the pump 8 and the homogenizer 12, an inlet and/or outlet line 22, which can be opened or closed with a valve 24, branches off from the conduit 10. The line 22, for its part, is connected to a connection 26 with an inlet/outlet fitting (not shown), which can be used to withdraw sample quantities from the on-going process for example, or to introduce liquid or solid additives into the process.

Furthermore, the line 22 is connected to a heat exchanger 28, so that, in the manner of a parallel circuit, a by-pass branch is formed around the homogenizer 12, which leads via a line 30 and a fitting 32 and ends in an output line 34 of the homogenizer 12.

Connected to the fitting 32, which may, for example, be a three-way valve or a multi-way valve, is a lower return line 36, which ends in a lower portion of the boiler 1, and/or (in this case, both are shown) an upper return line 38, which ends in an upper portion of the boiler 1.

A cleaning line 40 follows the upper return line 38, possibly via further valves, and is connected to a cleaning sprinkler head 39 in order to perform “Cleaning in Place” (CIP), in which a washing liquid, which is usually low-viscosity and is often aqueous, is used, and which is circulated with the pump 8 while the homogenizer 12 is running at a moderate speed or is standing still. If the homogenizer is standing still, it offers a great deal of resistance, so that the cleaning could then be performed in the by-pass. However, the homogenizer itself also has to be cleaned, and in that case it is preferred that the homogenizer should run at a moderate speed, so that it does not cause any noticeable loss of pressure or even a slight increase in pressure. It is advantageous here that, unlike the systems used in the past, no cavitation can occur in the homogenizer at elevated washing temperatures with absolute pressures close to the vapour pressure.

The single arrows in the lines in FIG. 1 indicate the direction of flow in normal operation, while the double arrow 42 indicates the infeed or removal via the connection 26, and the double arrow 44 in line 30 and the arrow 46 point to a possible removal via the fitting 32.

Depending on the operating mode, the pump 8 performs different tasks and can ideally process both products with very high viscosities and high solids contents and also products with very low viscosities, e.g. aqueous solutions.

In principle, any type of pump construction is conceivable, positive-displacement pumps such as reciprocating pumps being less suitable, whereas centrifugal pumps, on the other hand, are particularly advantageous.

In the design of centrifugal pump which is considered in detail in the following, the geometry of the pump impeller is preferably selected such that a moderate build-up of pressure with, for example, a maximum of 5 bar is possible. The volume flow to be delivered then corresponds to the operating mode concerned. When homogenizing more highly viscous substances, the maximum volume flow of the pump corresponds to the maximum volume flow to be processed by the homogenizer, while the pressure and volume flow during cleaning (CIP) with a low-viscosity washing liquid corresponds to the ideal characteristic curve of the CIP nozzles mounted in the cleaning head.

In the context of the invention, centrifugal pumps according to the radial pump principle with central axial intake and a pump impeller geometry that allows for high to very high viscosities are particularly suitable. Another reason why a radial pump is particularly suitable is that it makes it possible to allow products through at low speeds with little loss of pressure, i.e. it is “permeable” in the broadest sense of the word.

In addition, a pump which is advantageous in the context of the invention stands out because, compared to the homogenizer, it leads to a minor shearing action of the product, i.e. it is low-shear in the broadest sense of the word.

In the case of an arrangement immediately beneath the boiler floor 6, as illustrated in FIG. 1, a large cross-section is available for the intake, and hardly any loss of pressure in the feed line to the pump.

It is appropriate for additives in powder or liquid form to be delivered not into the pump inlet, but rather, as shown in FIG. 1, downstream of the pump and upstream of the homogenizer, so that the pressure loss in the intake orifice of the pump is reduced. In the event of faults in aspirating powders, this is able to prevent a powder blow-out (backflow) directly into the boiler, since the pump acts as a barrier to some extent.

Depending on the operating mode of the system, different local pressures or pressure curves are appropriate, which are illustrated by way of example in the following table.

Absolute pressures in bar, ideal values:

| | In the boiler | Downstream of the pump | Downstream of the |
|---|---|---|---|
| Operating mode | (Upstream of the pump) | (Upstream of the homogenizer) | homogenizer |
| Maximum shear input | 0.5 to 1 | 2 to 4 | 0.8 to 2 |
| | | (medium speed) | (pressure loss line) |
| High shear input | 0.2 to 0.5 to 1 | 3 to 5 | 0.6 to 1.5 |
| | | (very high speed) | (pressure loss line) |
| Aspiration | 0.2 to 0.5 | 0.2 to 0.5 | 0.6 to 0.8 |
| | | (low speed) | (pressure loss line) |
| Cold-Hot | 0.2 to 0.5 | 0.2 to 0.5 | 0.6 to 0.8 |
| | | (very low speed) | (high speed) |
| Low shear input | 1 (atmospheric) | 2 to 3 | 1 (atmospheric) |
| | | (medium speed) | homog. standing still |
| Removal upstream of | 1 (atmospheric) | 2 to 5 | 1 to 2 (atmospheric) |
| homog. | | (very high speed) | homog. standing still |
| By-pass via heat | | | |
| exchanger | | | |
| CIP | 1 (atmospheric) | 3 to 5 | 3 to 5 |
| | | (characteristic curve CIP | (characteristic curve |
| | | nozzles) | CIP nozzles) |

The separate arrangement and the separate drive of the pump and the homogenizer leads, in accordance with the invention, to the advantage both that the maximum inputs of shear energy in the homogenizer are possible, without there being any risk of cavitation, since the pump can provide the necessary pressure, and that the lowest inputs of shear energy are caused, e.g. when removing shear-sensitive goods, because the pump includes a favorably shaped impeller which is designed to achieve the optimum increase in pressure with the lowest possible input of shear energy.

In addition, solids and liquids can be introduced directly into the rotor-stator system, such as via the valve 24 between the pump and the homogenizer, and the same connection can also be used for removal purposes.

Depending on the situation in which it is being used, the homogenizer may or may not include a pump impeller stage upstream or downstream. In this way, the rotor can have a simple design if required.

When feeding in additives via the fitting 24, it may be appropriate for the pump to work at low speed and in effect merely to counterbalance the pressure loss of the pump, so that essentially the same absolute pressure exists in the boiler both upstream and downstream of the pump, which as a rule will be a technical vacuum (such as 200 to 400 mbar), so that this partial vacuum is also present at the valve 24 and can be used for aspiration.

1. A process for homogenizing a pumpable product, comprising the steps of:
pressurizing and homogenizing a product in an homogenization means equipped with a drive which has a drivable rotor rotatably mounted in a housing, and a stator that is stationary or drivable at an adjustable relative speed relative to the rotor;
applying a pressure, which can be set independently of the drive of the homogenization means, to the product upstream of the homogenization means by means of a pump means equipped with a separate drive; and
controlling the pressure such that no cavitation occurs in the homogenization means.

2. The process as claimed in claim 1, wherein the pressure is controlled by a map-controlled control unit, a characteristic map containing at least the speed of the homogenization means and the nature of the product as input parameters and is based on data either measured in advance or calculated.

3. The process as claimed in claim 1, wherein the pressure is controlled by a controller with a computing unit, wherein the computing unit uses empirically or theoretically determined correlations between at least the speed of the homogenization means and at least one characteristic property of the product, on the one hand, and the pressure required in order to avoid cavitation, on the other hand, in order to calculate the pressure on that basis.

4. A device for homogenizing a pumpable product, comprising:
an homogenization means which has a drivable rotor rotatably mounted in a housing, and a stator that is stationary or drivable at an adjustable relative speed relative to the rotor;
a pump means upstream of the homogenization means;
wherein the pump means can be driven independently of the homogenization means, there being associated with the pump means a control unit connected to a pressure sensor disposed upstream of the homogenization means in order to detect a pressure, which is designed to control the pressure such that no cavitation occurs in the homogenization means.

5. The device as claimed in claim 4, wherein the control unit is map-controlled, with a characteristic map containing at least the speed of the homogenization means and the nature of the product as input parameters and based on data either measured in advance or calculated.

6. The device as claimed in claim 4, wherein the control unit includes a computing unit which is arranged in such a way that uses empirically or theoretically determined correlations between at least the speed of the homogenization means and at least one characteristic property of the product, on the one hand, and the pressure required in order to avoid cavitation, on the other hand, in order to calculate the pressure on that basis.

7. The device as claimed in claim 4, wherein the pump means and the homogenization means are disposed in a common housing.

8. The device as claimed in claim 4, wherein the pump means has a separate pump housing.

9. The device as claimed in claim 4, wherein the homogenization means and the pump means are disposed spatially apart from one another and connected by a conduit.

10. The device as claimed in claim 4, wherein the pump means is disposed vertically beneath a product boiler.

11. The device as claimed in claim 4, wherein the pump means is designed as a single or multi-stage radial or axial pump.

12. The device as claimed in claim 4, wherein at least one fitting, in particular a valve, is disposed between the pump means and the homogenization means.

13. The device as claimed in claim 4, wherein a particle size sensor and/or a flow meter is/are disposed between the pump means and the homogenization means.

14. The device as claimed in claim 4, wherein a pressure measuring means and/or a particle size sensor and/or a flow meter is/are disposed downstream of the homogenization means.

15. The device as claimed in claim 4, wherein the homogenization means includes a pumping stage which is joined to the rotor such that it cannot rotate independently.

16. The device as claimed in claim 4, wherein a by-pass branch containing a heat exchanger is disposed in a parallel circuit to the homogenization means and surrounding the latter.

17. The device as claimed in claim 15, wherein the pumping stage is a pump impeller.
